(19) United States
(12) Patent Application Publication
(10) Pub. No.: US 2011/0106678 A1
(43) Pub. Date: May 5, 2011

(54) METHODS AND SYSTEM FOR RELOCATING THE CLIENT PORT IN THE PROCESS OF ONLINE PREPAYING

(75) Inventor: Wei Hua Zhou, Beijing (CN)

(73) Assignee: NOKIA SIEMENS NETWORKS OY, Espoo (FI)

(21) Appl. No.: 12/995,511

(22) PCT Filed: Jun. 2, 2009
(86) PCT No.: PCT/EP09/56735

§ 371 Date: Dec. 1, 2010

(30) Foreign Application Priority Data
Jun. 3, 2008 (CN) 200810100021.5

(51) Int. Cl. G06Q 30/00

(52) U.S. Cl. 705/34

(57) ABSTRACT

This invention is concerned with a system and some methods to maintain the continuity of online billing through a proxy server as an anchor in which it forwards the information between the prepaying client port and the prepaying server through the proxy server. The method includes the following steps:
a) When the user moves, it will relocate the prepaying client port between the old prepaying client port and the new one. It will also recertify the mobile station in the new prepaying port.
b) After the successful recertification, the old online billing information in the context will be transferred from the old prepaying client port to the new one.
c) After the transfer, the old prepaying client port will send the request message of credit-controlling which instructs the talk state to the proxy server, and then the prepaying agent will request quota to the prepaying server through the new prepaying port.

Thus, it will simplify the structure of online billing through the proxy server.

The present specifications aim to demand the prioritisation of the application for China's invention patent, which was numbered 200810087208.6 and submitted on Mar. 24, 2008. The invention was entitled “continuous method of online billing anchoring the authentication, authorization and accounting server.”

### TECHNOLOGY

The present invention is concerned with the mobility-related approach to the relocation of the prepaying client port, especially in relation to the methods and systems of Relocating the Client Port in the Process of Online Prepaying, in order to maintain the continuity of online billing.

### BACKGROUND OF TECHNOLOGY

Diameter Credit Control Application (DCCA) was designed by the Internet Engineering Task Force (IETF) and expanded by the Third Generation Partnership Project (3GPP) in order to be used as the control protocol for online billing. DCCA was based on the client port (the prepaying port of client PPC)/server (prepaying server PPS) mode. In the DCCA, the prepaying client port was designed with the anchor unit in the same network. When the user moves to the 3G network, the prepaying client port will not change because the anchor point, which is supported by the GPRS gateway, will not change. Thus, it is not necessary to consider issues of mobility in the use of such a network billing structure. FIG. 1 demonstrates this.

However, as networks become more and more flat, some online billing functions were moved to access point of Access Service Network Gateway (ASNGW) in some networks such as WiMAX, not only focusing on the anchor (refer to FIG. 2, which shows the architecture of Diameter online billing in the WiMAX network). When the user moves, the mobile station may be moved from one ASNGW/PPC to another ASNGW/PPC. In this case, the prepaying client port should be repositioned, and billing should also be ensured with continuity in order to support the continuity of the users' talking. The existing DCCA obviously cannot meet the need.

In the patent application numbered with 200810003790.3 which was submitted on Jan. 23, 2008, I discussed the case of direct connection between the prepaying client port and the prepaying server. The content of this patent application is focusing on this point by reference. However, the patent application is only for the case of direct connection between the prepaying client port and the prepaying server. There is still no solution available until now to the case of connecting the prepaying client port with the prepaying server through a proxy server as a mobile anchor.

### SUMMARY OF THE INVENTION

This invention is for maintaining the continuity of online billing through a proxy server acting as an anchor, thus solving the problem of the continuity of online billing when connecting the prepaying client port with the prepaying server through a proxy server.

On the one hand, this invention maintains the continuity of online billing through a proxy server as an anchor. It forwards the information between the prepaying client port and the prepaying server through the proxy server.

The method includes the following steps: When the user moves, it will relocate the prepaying client port between the old prepaying client port and the new one. It will also recertify the mobile station in the new prepaying port.

After the successful recertification, the old online billing information in the context will be transferred from the old prepaying client port to the new one.

After the transfer, the old prepaying client port will send the request message of credit-controlling which instructs the talk state to the proxy server, and then the prepaying agent will request quota to the prepaying server through the new prepaying port.

In this method, online billing, authentication and authorization share a conversation or own an independent conversation separately. And the conversation between the proxy server and the prepaying port will not be disturbed by the relocation of the prepaying client port.

The property attribute value of the conversation state will be defined in the message of credit-controlling request. It could be defined as “continuing conversation” and “beginning conversation”. Among them, the “true” value of the “conversation continuing” indicates that the conversation will be continued from another new conversation from the new prepaying client port. The “false” value or the lack of the attribute value of “continuing conversation” indicates that conversation will be terminated. While the “false” value of “beginning conversation” indicates that the conversation is a continuation of the conversation from the old prepaying client port. The “true” value, or the lack of the attribute value of “beginning conversation”, indicates that the conversation is a new one.

The relocation of the prepaying client port could be realized by the modes of pushing and pulling between the old and new prepaying client ports. In addition, mobile stations can be recertified through stages of an extensible authentication protocol and PKMv2 3WHS.

After the detection of the successful recertification, the new prepaying client port will launch R4 repositioning to fulfill the business processing. R4 repositioning includes: Sending a request message of the completion of relocation, the new prepaying client port informs to the old prepaying client port the successful completion of recertification process. The old prepaying client responds according to the messages of repositioning. Meanwhile, when the old prepaying client port receives the confirmation message of the completion of repositioning, it will delete the context of the mobile station. Among them, the new prepaying client port is located in the “online accounting context” indexing the context to indicate a request for the context of the old prepaying client port. And the response message of the relocation includes the contexts of the old prepaying client port and the mobile station.

Before the prepaying agent requests quota to the prepaying server through the new prepaying port, the new prepaying client port will send the information of context to the prepaying agent in order to take advantage of the location/identity of the new prepaying client port to update the prepaying agent.

On the other hand, this invention provides a system to maintain the continuity of online billing through a proxy server as an anchor. It forwards the information between the prepaying client port and the prepaying server through the proxy server. The system also includes: repositioning devices for launching relocation of prepaying client port; contextual messaging devices used to transfer the old online billing information in the context from the old prepaying client port to the new one; devices for sending credit-controlling requests used to send the request message of credit-controlling which instructs the talk state to the proxy server; and devices for requesting quota used to request quota to the prepaying server through the new prepaying port.

According to the above-mentioned aspects of the present invention, the system has the following advantages:

The prepaying server does not know the mobility of the prepaying client's port, so that there is no new requirement to the prepaying server.

It is easier for the proxy server to support transmitting the information of DCCA between the prepaying client port and the prepaying server. Accordingly, the present invention is easily to be implemented.

It is exempt from the message exchange between the prepaying client port and the prepaying server.

It simplifies the structure of online billing because the prepaying client port does not need to know the prepaying server address. Therefore, it reduces complexity through the proxy server.

According to the expanding program of the present invention, it invents a method to maintain the continuity of online billing through a proxy server as an anchor in which it forwards the information between the prepaying client port and the prepaying server through the proxy server. The method includes the following steps:

When the user moves, it will relocate the prepaying client port between the old prepaying client port and the new one. It will also recertify the mobile station in the new prepaying port.

After the successful recertification, the old online billing information in the context will be transferred from the old prepaying client port to the new one. At the same time, the new prepaying client port sends the message of credit request to the proxy server. The message is carrying the attributes of old billing conversation which indicate that the new billing conversation is a continuation of the old billing one. And the proxy server confirms the update of the conversation by sending a blank message of credit response and establishes a conversation with the new prepaying client port.

When the transfer of the context information is completed and the update of conversation is confirmed by the proxy server, the attributes of the prepaying client port are to be updated and the old billing conversation is to be terminated.

According to another expanding program of this invention, this invention provides a system to maintain the continuity of online billing through a proxy server as an anchor. It forwards the information between the prepaying client port and the prepaying server through the proxy server. The system also includes: repositioning devices for launching relocation of prepaying client port; contextual messaging devices used to transfer the old online billing information in the context from the old prepaying client port to the new one; devices for sending credit-controlling requests used to send the request message of credit-controlling which instructs the talk state to the proxy server, and the message is carrying the attributes of old billing conversation which indicate the new billing conversation is a continuation of the old billing one; devices for sending credit responses, used to send a blank message of credit responses from the proxy server to the new prepaying client port to confirm the update of the conversation and establish a conversation with the new prepaying client port; devices for updating the attributes, used when the transfer of the context information is completed and updates of conversation are conformed by the proxy server; and devices for terminating the conversation billing, used to update the attributes of the prepaying client port and terminate the old billing conversation.

According to the above-mentioned expanding programs and systems of the present invention, they can further reduce the time spent by the prepaying agent to the quota with the adoption of a new prepaying client port. Therefore, they can further improve the system performance.

In this invention, the proxy server is a server part of authentication, authorization and accounting (AAA). It is also an independent component or part of prepaying server. Attributes of conversation billing is the conversation ID.

The online conversation billing in this invention could be Diameter online billing or Radius online billing. And methods of the present invention can be used for WiMAX networks or LTE/SAE and other similar networks.

### BRIEF DESCRIPTION OF THE DRAWINGS

Combined with the following figures of the invention, the following will describe the invention in a more detailed way, in which:

FIG. 1 shows the online charging structure of Diameter;

FIG. 2 shows the online charging structure of Diameter in WiMAX network;

FIG. 3 shows the relocation program of the prepaying client port by the anchor of AAA server based on the Diameter protocol for online billing used in this invention;

FIG. 4 shows the process of the relocation program of the prepaying client port shown in FIG. 3;

FIG. 5 is similar to that of FIG. 3, which shows the relocation program of the prepaying client port by the anchor of PPS server based on the Diameter protocol for online billing used in this invention;

FIG. 6 shows the process of the relocation program of the prepaying client port shown in FIG. 5.

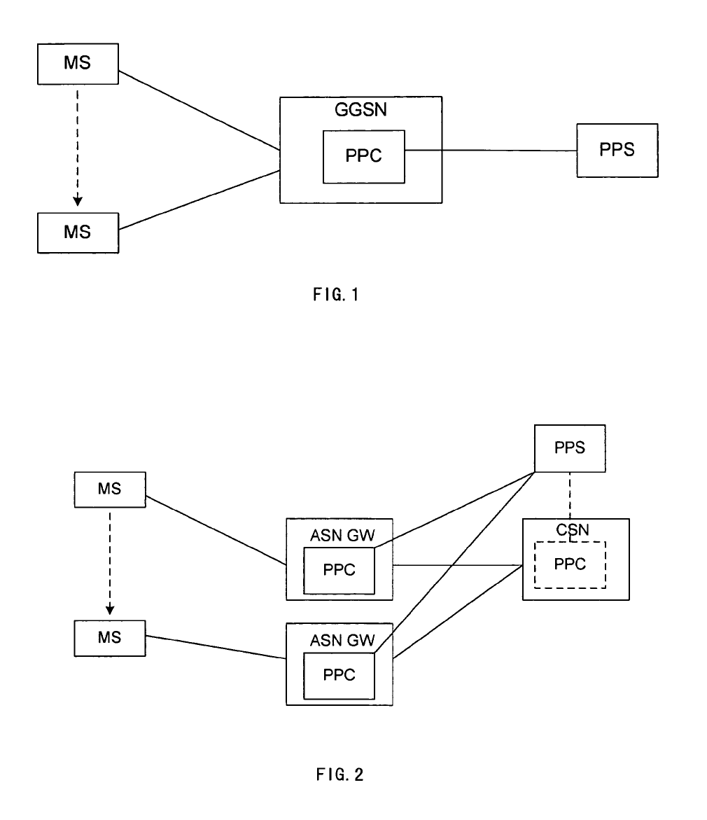

### DETAILED DESCRIPTION OF EXEMPLARY EMBODIMENTS

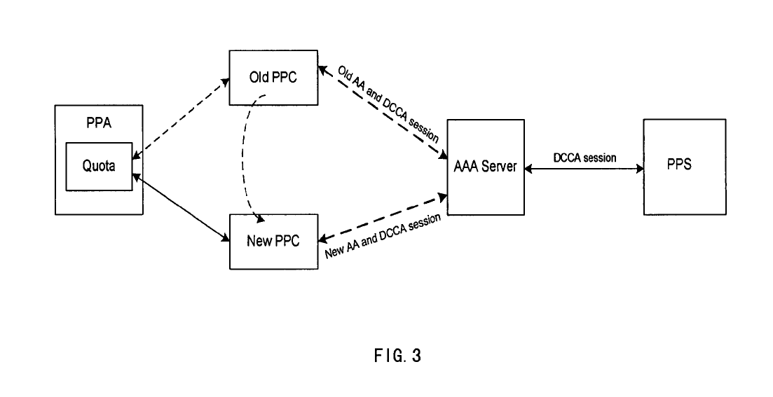

The following relocation programs of the prepaying client port are put forward by the anchor of AAA server based on the Diameter protocol for online billing used in these inventions which are shown in FIG. 3.

1. The DCCA message is transmitted between the prepaying client port and the prepaying server through the AAA server.

2. Online billing can be shared a Diameter conversation with authentication and authorization or it can enjoy an independent Diameter conversation.

3. After successful relocation, the DCCA context information will be transferred from the old prepaying client port to the new one. And after the transfer, the old prepaying client port will send the message of credit-controlling request (CCR) (termination, the continuation of the conversation=“true”) to the AAA server to instruct that the conversation will be continued as a new conversation from the new prepaying client port.

In the conversation state, the pair of two new attribute values of AVP are defined, which will be used in the CCR message to indicate the status of the conversation. One AVP is a “continuing conversation”, and its value is “true” or “false.” “True” value means that the conversation from the new prepaying client port will be continued. “False” value or the absence of this AVP implies that the conversation should be terminated.

The other AVP is ‘beginning the conversation’ and its value is ‘true’ or ‘false’. The “false” value indicates that the conversation is a continuation of the conversation from the old client. The “true” value or the lack of the attribute value indicates that the conversation is a new one.

4. The new online billing can be shared a Diameter conversation with authentication and authorization or it can enjoy an independent Diameter conversation.

5. When reaching the preset threshold of remaining quota or consuming the entire quota out, the agent of prepaying will require quota to the prepaying server through the prepaying client port. The initial CCR News from the new prepaying client port to the AAA server should be CCR (update, the beginning of the conversation=false), which indicates that the user's conversation is a continuation of the previous one.

6. The DCCA conversation between the AAA server and the prepaying server has not been impacted by the relocation of the prepaying client port.

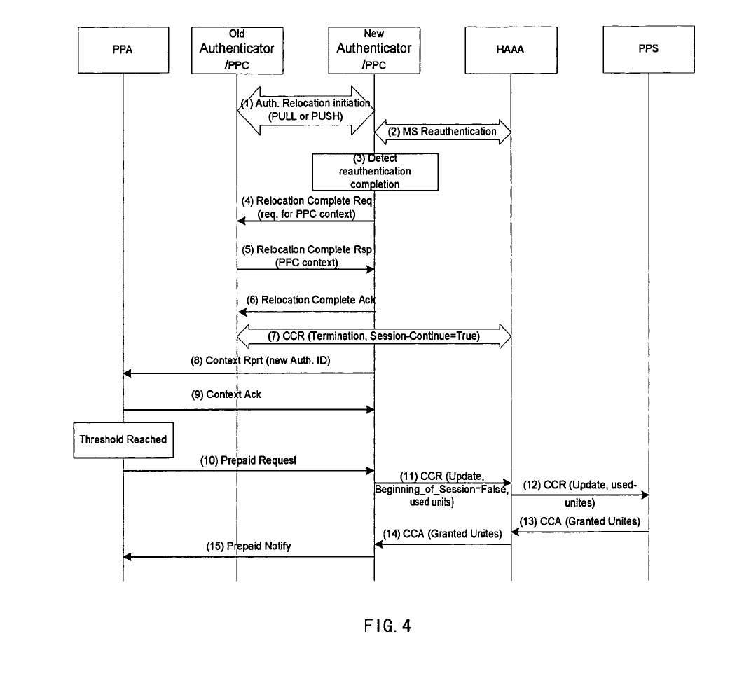

In view of this program, FIG. 4 shows the detailed process of repositioning of the prepaying client port. In Step 1, the relocation of the prepaying client port could be realized by the modes of pushing and pulling between the old and new prepaying client ports. In Step 2, mobile stations can be recertified in the new entity. This include stages of an extensible authentication protocol and PKMv2 3WHS. In step 3, if a new authentication device/prepaying client device detects the successful recertification (the successful completion of PKMv2 3WHS stage), the new prepaying client port will launch R4 repositioning to fulfill the business processing. The R4 repositioning includes the following steps of 4, 5 and 6: In step 4, by sending a request message of the completion of relocation, the new prepaying client port/new authentication device informs the old prepaying client port/old authentication device about the successful completion of recertification process. The new prepaying client port is located in the “online accounting context” indexing the context to indicate a request for the context of the old prepaying client port. In step 5, the old prepaying client/old authentication responds according to the messages of repositioning, providing the contexts of the old prepaying client port and the mobile station. In step 6, the new authentication device/prepaying client port confirms the receipt of the news in response to the relocation by sending the confirmation message of repositioning. When the old prepaying client port receives the confirmation message of the completion of repositioning, it will delete the context of the mobile station. In step 7, the old authentication device/the prepaying client port prepaid puts out a CCR (“conversation continuation” tag is set to “true”) according to previous billing paragraph. In Step 8, the new authentication device/prepaying client port sends the context information to the anchor point (DP)/prepaying agent in order to take advantage of new authentication location/identity to update the anchor DP/prepaying agents. From this moment onwards, the prepaying agent communicates with the new prepaying client port. In step 9, the prepaying agent responds to the confirmation message of the context. In step 10, when reaching the preset threshold of remaining quota or consuming the entire quota, the agent of prepaying will require more quotas to the prepaying server through the prepaying client port. In step 11, the new prepaying client port generates CCR to the AAA server (update, the beginning of the conversation=false, having used the quota). In step 12, AAA server transmits the CCR (update, having used the quota) to the prepaying server through the initial DCCA conversation. In step 13, the prepaying server returns the message of CCA (the amount has been allocated) confirmed by credit control to the AAA server. In step 14, the AAA server also returns the message of the CCA (the amount has been allocated) to the new message authentication device/prepaying client port. In step 15, the new certification browser/prepaying client port responds to the prepaying agent through the message of prepaying notification.

In the above-mentioned cases of implementation, HAAA is used as the proxy server for Diameter online billing. In fact, the proxy server can also be other network components, and even the independent components. And the physical location of the proxy server depends on the realization of the program, for example, the proxy server can be part of the HAAA, independent or may be part of PPS.

In the example of implementation, the old authentication device/PPC will inform to the HAAA/proxy server. The conversation will be continued in a new browser/PPC. In reality, however, it is also possible for the new device/PPC to notify the proxy server at first. The conversation is a continuation of an old one. And this step can be completed very early, as the following specifies.

In the example of implementation, when the new PPC receives the “prepaying request” triggered by the arrival of the incident threshold from the PPA, the new PPC will establish a dialogue with the proxy server. Because the correspondence among PPA, HAAA/proxy server and PPS through PPC will be conducted in the wide area network, and PPC needs to set up a new Diameter conversation at first between sending request of quota and receiving it, it will be too long for PPA receiving the new quota through PPC. This will run out of the remaining quota, resulting in losing some packets.

Therefore, it is better to establish Diameter dialogue in advance. In another implementation example, an optimization is raised to solve the problem. In this solution, the creation of new conversation between a new PPC and the proxy server will be triggered by the recertification of PPC, rather than by the PPA.

When the new PPC establishes a new conversation with the proxy server, it does not need to request quotas. Therefore, it is different from the above proposed solutions. Because the conversation between the proxy server and PPS has not been changed, the duration time of sending and receiving the quota triggered by the reach of threshold of the quota will equal to the time of carrying out the old quota. The following steps 5 and 8 specify this.

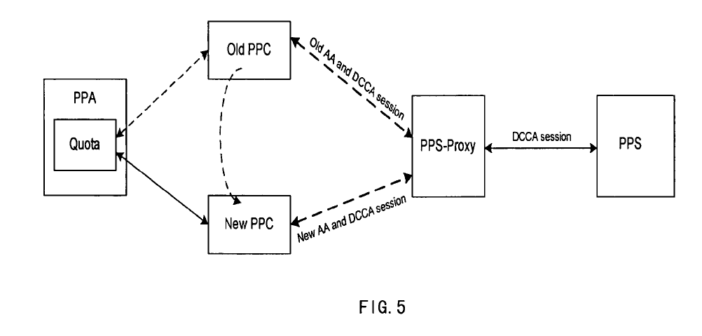

FIG. 5 shows the architecture similar to FIG. 3, which is a relocation program of the prepaying client port based on the Diameter online billing and the anchor of PPS proxy server. In the program, the physical location of PPS depends on the realization of the program, for example, the proxy server can be part of the HAAA, independent or may be part of PPS.

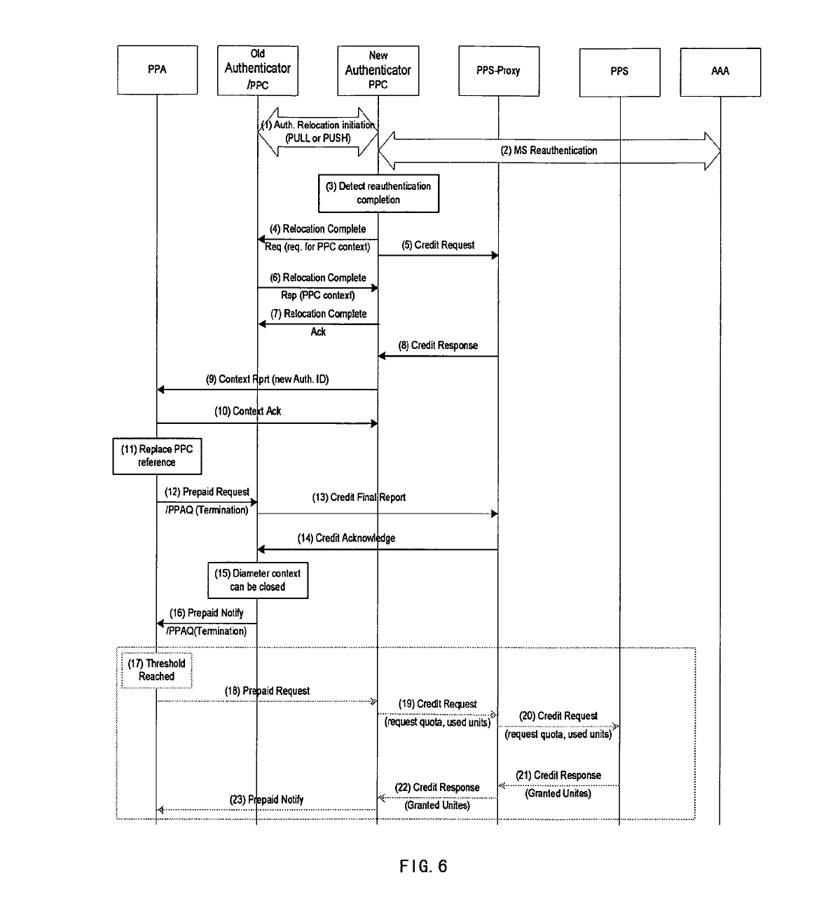

In view of this program, FIG. 6 shows in detail the process of repositioning of the prepaying client port. In Step 1, the relocation of the prepaying client port could be realized by the modes of pushing and pulling between the old and new prepaying client ports. In Step 2, mobile stations can be recertified in the new entity. This include stages of an extensible authentication protocol and PKMv2 3WHS. In step 3, if a new authentication device/prepaying client device detects the successful recertification (the successful completion of PKMv2 3WHS stage), the new prepaying client port will launch R4 repositioning to fulfill the business processing. The R4 repositioning includes the following steps of 4, 6 and 7: In step 4, by sending a request message of the completion of relocation, the new prepaying client port/new authentication device informs the old prepaying client port/old authentication device about the successful completion of recertification process. The new prepaying client port is located in the “online accounting context” indexing the context to show their support to online billing, and location of other “quota transfer” bit. In Step 5, the new authentication device/prepaying client port uses the old billing of conversation ID which is prescribed as one of the attributes to send a credit request to PPS proxy server to create a new conversation. In step 6, the old prepaying client/old authentication responds according to the messages of repositioning, providing the contexts of the old prepaying client port and the mobile station. In step 7, the new authentication device/the prepaying client port confirms the receiving of the response message of relocation by sending the message of the confirmation of relocation. The old authentication device/the prepaying client port waits for the termination of prepaying of conversation requested by PPA. In step 8, by sending a blank message in response to the credit, PPS confirms the update of the conversation and establishes the dialogue of the new prepaying client port. In Step 9, after receiving messages of repositioning responses in Step 6 and messages of credit responses in Step 8, the new authentication device/prepaying client port sends the context information to the prepaying agent in order to take advantage of new authentication location/identity to update the prepaying agents. In step 10, the prepaying agent responds using the confirmation message of the context. In step 11, the agent of prepaying updates the prepaying client port to the properties of the new prepaying client port and continues the conversation on the basis of the existing quota. In step 12, the agent of prepaying terminates the old prepaying conversation, but it does not provide the information of using the quota. In step 13, the old authentication device/prepaying client port sends the report except the terminal credit report to trigger the closure of the old conversations. In step 14, the PPS proxy server confirms the closure of the conversation through the credit confirmation message. In step 15, the old authentication device/the prepaying client closes the prepaying context. In step 16, the old authentication device informs the agent: it has closed the conversation of the prepaying. Steps 17-23 are independent of the mobility and can be carried out at any time in the process of moving. These steps are shown out only to clarify the impact caused by the moving. That is, when the threshold meets the quota, it will trigger a general process to request a new quota.

Each step of the process shown in FIGS. 4 and 6 can be realized by the use of software, hardware or its combination.

This invention is consistent with the prepaying bill on the basis of the agreement of Radius in WiMAX R1.0. When the protocols of Radius and Diameter are used for authentication and authorization, the methods of the invention are useful.

Although this invention is described above with the attached figures combined with the network of WiMAX, it is not limited to these. It can be modified in various ways within the public scope in the attached claims.

1. A method for maintaining the continuity of online billing through a proxy server as an anchor, which forwards the information between the prepaying client port and the prepaying server through the proxy server, wherein the method includes the following steps:
a) when the user moves, it will relocate the prepaying client port between the old prepaying client port and the new one, wherein it will also recertify the mobile station in the new prepaying port;
b) after successful recertification, the old online billing information in the context will be transferred from the old prepaying client port to the new one;
c) after the transfer, the old prepaying client port will send the request message of credit-controlling which instructs the talk state to the proxy server, and then the prepaying agent will request quota to the prepaying server through the new prepaying port.

2. The method as claimed in claim 1, wherein the conversation between the proxy server and the prepaying port has nothing to do with the relocation of the prepaying client port.

3. The method as claimed in claim 1, wherein the online billing, the authentication and the authorization share a conversation or own an independent conversation separately.

4. The method as claimed in claim 1, wherein the property attribute value of the conversation state will be defined in the message of credit-controlling request.

5. The method as claimed in claim 4, wherein the property attribute value could be defined as “continuing conversation” and “beginning conversation”.

6. The method as claimed in claim 5, wherein the “true” value of the “conversation continuing” indicates that the conversation will be continued from another new conversation from the new prepaying client port, wherein the “false” value, or the lack of the attribute value of “continuing conversation”, indicates that conversation will be terminated.

7. The method as claimed in claim 5, wherein the “false” value of “beginning conversation,” indicates, that the conversation is a continuation of the conversation from the old prepaying client port, wherein the “true” value, or the lack of the attribute value of “beginning conversation”, indicates that the conversation is a new one.

8. The method as claimed in claim 1, wherein the relocation of the prepaying client port could be realized by the modes of pushing and pulling between the old and new prepaying client ports.

9. The method as claimed in claim 1, wherein mobile stations can be recertified through stages of an extensible authentication protocol and PKMv2 3WHS.

10. The method as claimed in claim 1, wherein after the detection of the successful recertification, the new prepaying client port will launch R4 repositioning to fulfill the business processing.

11. The method as claimed in claim 10, wherein sending a request message of the completion of relocation, the new prepaying client port informs the old prepaying client port about the successful completion of recertification process. The old prepaying client responds according to the messages of repositioning, wherein when the old prepaying client port receives the confirmation message of the completion of repositioning, it will delete the context of the mobile station.

12. The method as claimed in claim 11, wherein the new prepaying client port is located in the “online accounting context” indexing the context to indicate a request the context of the old prepaying client port.

13. The method as claimed in claim 11, wherein the response message of the relocation includes the contexts of the old prepaying client port and the mobile station.

14. The method as claimed in claim 1, wherein before the prepaying agent requests quota to the prepaying server through the new prepaying port, the new prepaying client port will send the information of context to the prepaying agent in order to take advantage of the location/identity of the new prepaying client port to update the prepaying agent.

15. The method as claimed in claim 1, wherein the online conversation billing in this invention comprises Diameter online billing or Radius online billing.

16. The method as claimed in claim 1, wherein the online billing is conducted in the WiMAX network, or LTE/SAE network.

17. The method as claimed in claim 1, wherein the proxy server is a server part of authentication, authorization and accounting, wherein it is also an independent component or part of prepaying server.

18. A system to maintain the continuity of online billing through a proxy server as an anchor, wherein it forwards the information between the prepaying client port and the prepaying server through the proxy server, wherein the system also includes repositioning devices for launching relocation of prepaying client port; contextual messaging devices used to transfer the old online billing information in the context from the old prepaying client port to the one; devices for sending credit-controlling requests used to send the request message of credit-controlling which instructs the talk state to the proxy server; and devices for requesting quota used to request quota to the prepaying server through the new prepaying port.

19. A method to maintain the continuity of online billing through a proxy server as an anchor in which it forwards the information between the prepaying client port and the prepaying server through the proxy server, wherein the method includes the following steps:
a) when the user moves, it will relocate the prepaying client port between the old prepaying client port and the new one. It will also recertify the mobile station in the new prepaying port;
b) after the successful recertification, the old online billing information in the context will be transferred from the old prepaying client port to the new one, wherein at the same time, the new prepaying client port sends the message of credit request to the proxy server wherein the message is carrying the attributes of old billing conversation which indicate the new billing conversation is a continuation of the old billing one, and wherein the proxy server confirms the update of the conversation by sending a blank message of credit response and establishes a conversation with the new prepaying client port;
c) when the transfer of the context information is completed and updates of conversation is conformed by the proxy server, the attributes of the prepaying client port are to be updated and the old billing conversation is to be terminated.

20. The method as claimed in claim 19, wherein the conversation between the proxy server and the prepaying port has nothing to do with the relocation of the prepaying client port.

21. The method as claimed in claim 19, wherein the relocation of the prepaying client port could be realized by the modes of pushing and pulling between the old and new prepaying client ports.

22. The method as claimed in claim 19, wherein mobile stations can be recertified through stages of an extensible authentication protocol and PKMv2 3WHS.

23. The method as claimed in claim 19, wherein after the detection of the successful recertification, the new prepaying client port will launch R4 repositioning to fulfill the business processing.

24. The method as claimed in claim 23, wherein sending a request message of the completion of relocation, the new prepaying client port informs the old prepaying client port about the successful completion of recertification process, and wherein the old prepaying client responds according to the messages of repositioning.

25. The method as claimed in claim 24, wherein the new prepaying client port is located in the “online accounting context” indexing the context to indicate a support to online billing, and wherein the new prepaying client port is also installed with “quota transfer” bit.

26. The method as claimed in claim 24, wherein the response message of the relocation includes the contexts of the old prepaying client port and contexts of the mobile station in the position of the prepaying agent.

27. The method as claimed in claim 19, wherein when the transfer of the context is over and the agent server confirms the update of the conversation, the new prepaying client port will send the information of context to the prepaying agent in order to take advantage of the location/identity of the new prepaying client port to update the prepaying agent.

28. The method as claimed in claim 19, wherein the proxy server is a server part of authentication, authorization and accounting. It is also an independent component or part of prepaying server.

29. The method as claimed in claim 19, wherein the online conversation billing in this invention could be Diameter online billing or Radius online billing.

30. The method as claimed in claim 19, wherein the online billing could be conducted in the WiMAX network, or LTE/SAE network.

31. (canceled)
